(19) United States
(12) Patent Application Publication
(10) Pub. No.: US 2004/0249672 A1
(43) Pub. Date: Dec. 9, 2004

(54) Preventive care health maintenance information system

(76) Inventors: Siegfried Bocionek, Nuerenberg (DE); Joseph R. Cseh, Chester Spring, PA (US); Volker Schmidt, Erlangen (DE)

Correspondence Address: Alexander J. Burke, Intellectual Property Department, 5th Floor, 170 Wood Avenue South, Iselin, NJ, 08830, US

(21) Appl. No.: 10/797,428

(22) Filed: Mar. 10, 2004

Related U.S. Application Data
(60) Provisional application No. 60/453,436, filed on Mar. 10, 2003.

(51) Int. Cl. G06F 17/60

(52) U.S. Cl. 705/2

(57) ABSTRACT

A system provides a user with preventive care health maintenance information during a user's lifetime. A stored medical record is associated with a particular user. A repository of health maintenance guidelines and associated time information is customized for the particular user based on characteristics including age, sex, and health condition. A processor employs the guidelines, associated time information, and retrieved medical record information of the particular user to initiate generation of a message at a particular time. The message prompts the particular user to initiate action in support of preventive care health maintenance of the particular user. A communication processor processes the message for output communication.

### CROSS-REFERENCE TO RELATED APPLICATIONS

The present application is a non-provisional application of provisional application having Ser. No. 60/453,436 filed by Joseph R. Cseh, et al. on Mar. 10, 2003.

### FIELD OF THE INVENTION

The present invention generally relates to information systems for health care management. More particularly, the present invention relates to a preventive care health maintenance information system and method therefore.

### BACKGROUND OF THE INVENTION

Due to the increasing complexity and cost of providing health care, there is an increasing emphasis on managing the health care process. The process extends from an individual presenting a health concern to a health care provider and continues through diagnosis, therapeutic selection, resource selection, treatment, and follow-up. This process could be extended further to include proactively identifying or preventing health concerns and planning for anticipated resource needs at one end of the process, and daily nursing management and disability management at the other end of the process.

The process of proactively identifying or preventing health concerns and planning for anticipated resource needs encourages lower costs of healthcare delivery. A challenge is to change people's behavior so that they are proactive in disease identification and prevention practices. For example, based on current medical knowledge, people should visit a dentist twice a year even if they have no toothache, women over the age of forty should have their breasts examined regularly, and men over the age of fifty should have their prostrate examined regularly, and so forth. Reasons that people do not take a proactive role in their own healthcare include: little knowledge about the advantages, inconvenience in finding the right doctor and spending the required time, no sense of urgency due to their overall satisfactory health condition, no real incentive from the payers (although sometimes positive incentives are linked to proactive preventative behavior).

Previous efforts to manage health care included manual-historical systems where individual files recording actual treatment provided were manually reviewed to collect statistics on general categories of care or to review the appropriateness of in a given case. Such methods are labor-intensive and inefficient. Efforts have been made to standardize data collection forms, descriptions of conditions, descriptions of treatment, and treatments in order to more efficiently collect and evaluate health care data. Other efforts have been made to automate the analysis of historical health care data for persons with particular health care conditions. These efforts focus mainly on collecting financial data and serve accounting and administrative functions.

Prior automated health care management systems addressed therapeutic selection by starting with a selected treatment and, based on patient information provided by the user, evaluating whether or not that treatment is appropriate. Such systems do not permit the definition, maintenance, and automated execution of a person's lifelong health guide to solve the problems described above. These systems also do not have the flexibility to modify or add treatments or schedules based on an individual's changing health condition. A system according to invention principles addresses these deficiencies and associated problems.

### SUMMARY OF THE INVENTION

It would be an improvement over the prior art to have a health care management information system that could be used by various health care participants, including patients, doctors, nurses, health care administrators, payer administrators, employers, and evaluators at multiple stages of the health care process. It would be a further improvement for such a system to collect information on individuals having a health concern, to guide the user to a system-selected treatment based on the information collected. The prior art systems also leave an unsatisfied need for providing a system that changes people's behavior so that they are proactive in disease identification and prevention practices. A further improvement over the prior art would be for such a system to permit continuous updating and modification of the experience base, using the information input into the process for each case.

A system implementing the above process should ideally have several qualities. It should be cost-effective, i.e., lead to reducing the total cost of health care. It should be usable in real-time, i.e., the information input into the system should be immediately processed and available for further use. It should be interactive, allowing a variety of health care participants to understand and effectively use the system. It should be flexible enough to adapt to changes in and evolution of health care professional knowledge and health care treatment methods. Accordingly, there is a need for a preventive care health maintenance information system and method therefor that overcomes these and other disadvantages.

According to one aspect of the present invention, a system provides a user with preventive care health maintenance information during a user's lifetime. A stored medical record is associated with a particular user. A repository of health maintenance guidelines and associated time information is customized for the particular user based on characteristics including age, sex, and health condition. A processor employs the guidelines, associated time information, and retrieved medical record information of the particular user to initiate generation of a message at a particular time. The message prompts the particular user to initiate action in support of preventive care health maintenance of the particular user. A communication processor processes the message for output communication.

### BRIEF DESCRIPTION OF THE DRAWINGS

FIG. 1 illustrates a preventative care health maintenance information system, in accordance with a preferred embodiment of the present invention.

FIG. 2 illustrates a general process for the preventative care health maintenance information system, as shown in FIG. 1, in accordance with a preferred embodiment of the present invention.

FIG. 3 illustrates a particular process for the preventative care health maintenance information system, as shown in FIG. 1, in accordance with a preferred embodiment of the present invention.

FIG. 4 illustrates a sub-process for the preventative care health maintenance information system, as shown in FIG. 1, in accordance with a preferred embodiment of the present invention.

FIG. 5 illustrates the preventative care health maintenance information system, as shown in FIG. 1, implemented as a personal computer in a centralized configuration in accordance with a preferred embodiment of the present invention.

FIG. 6 illustrates the preventative care health maintenance information system, as shown in FIG. 1, implemented as a personal computer in a distributed configuration in accordance with a preferred embodiment of the present invention.

FIG. 7 illustrates the preventative care health maintenance information system, as shown in FIG. 1, implemented in a portable configuration in accordance with a preferred embodiment of the present invention.

### DETAILED DESCRIPTION OF THE PREFERRED EMBODIMENTS

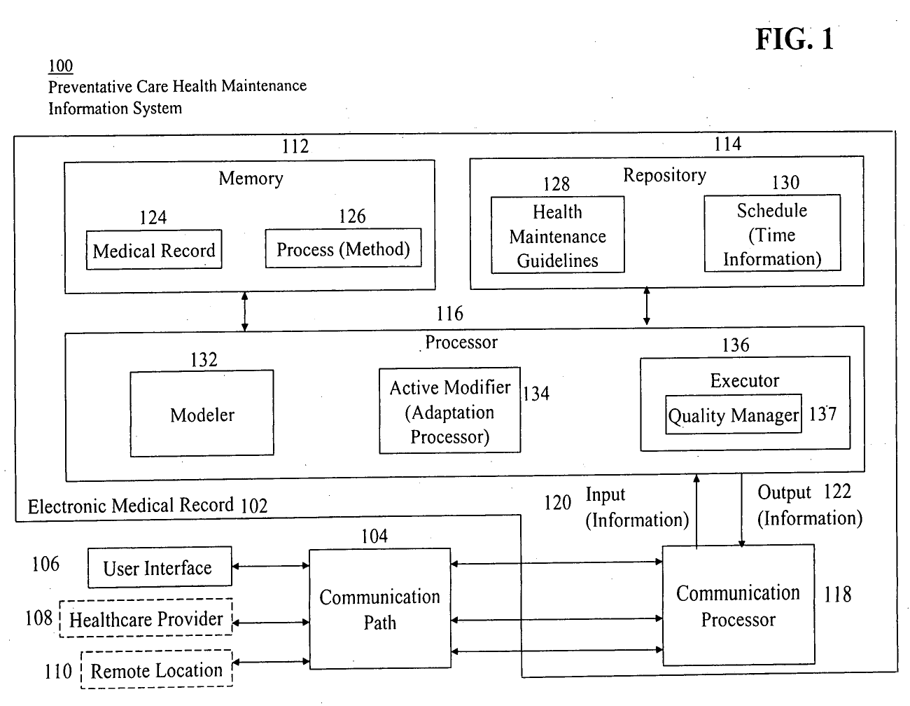

FIG. 1 illustrates a preventative care health maintenance information system 100 (herein called the “system”), in accordance with a preferred embodiment of the present invention. The system 101 is intended for use by a person being serviced by a healthcare provider that is responsible for monitoring the health and/or welfare of people in its care. Thus, a healthcare provider may provide services directed to the mental, emotional, or physical well being of a patient. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. In the preferred embodiment of the present invention, the healthcare provider is a hospital. A healthcare provider diagnoses a condition, or disease, and recommends a course of treatment to cure the condition, if such treatment exists, or provides preventative healthcare services. Examples of the people being serviced by the healthcare provider include, without limitation, a patient, a resident, and a client (herein each type of person otherwise called a “user” or an “individual”).

The system 100 generally includes an electronic medical record (EMR) system 102, a communication path 104, and a user interface 106. FIG. 1 also illustrates a healthcare provider 108 and a remote location 110, each of which may interface with the EMR system 102 via the communication path 104. The EMR system 102 further includes a memory 112, a repository 114, a processor 116, and a communication processor 118. The memory 112 further includes a medical record 124 and a process (otherwise called a “method”) 126. The repository further includes health maintenance guidelines 128 and a schedule (otherwise called “time information”) 130. The processor 116 further includes a modeler 132, an active modifier (otherwise called an adaptive processor) 134, and an executor 136. The executor 136 (otherwise called a “monitor”) further includes a quality manager 137.

The processor 116 manages the functions of the EMR system 102 responsive to the process 126. The processor 116 further manages the communications between the EMR system 102 and the user interface 106, healthcare provider 108, and/or the remote location 110, via the communication processor 118. The processor 116 is electrically coupled to the memory 112, the repository 114, and the communication processor 118 over bi-directional paths. The bi-directional path between the processor 116 and the communication processor 118 further includes an input path 120 and an output path 122. The input path 120 carries information from the communication processor 118 to the processor 116. The output path carries information from the processor 116 to the communication processor 118. The EMR system 102 communicates with one or more of the user interface 106, the healthcare provider 108, and the remote location 110 via the communication path 104.

The system 100 provides advantageously provides a lifelong electronic health tool and guide for a person to encourage proactive preventative and/or treatment of the person's lifelong healthcare needs. The system 100 may be maintained either at a healthcare provider's site (e.g., a home health agency), or also at the individual's home. The system includes an electronic medical record (EMR) system 102 (preferably, small), together with a process 126 that models the lifelong care and prevention activities for a specific individual. The care and prevention activities are tailored to the age, sex, and health status of the individual. The process description provides the lifelong electronic health guide.

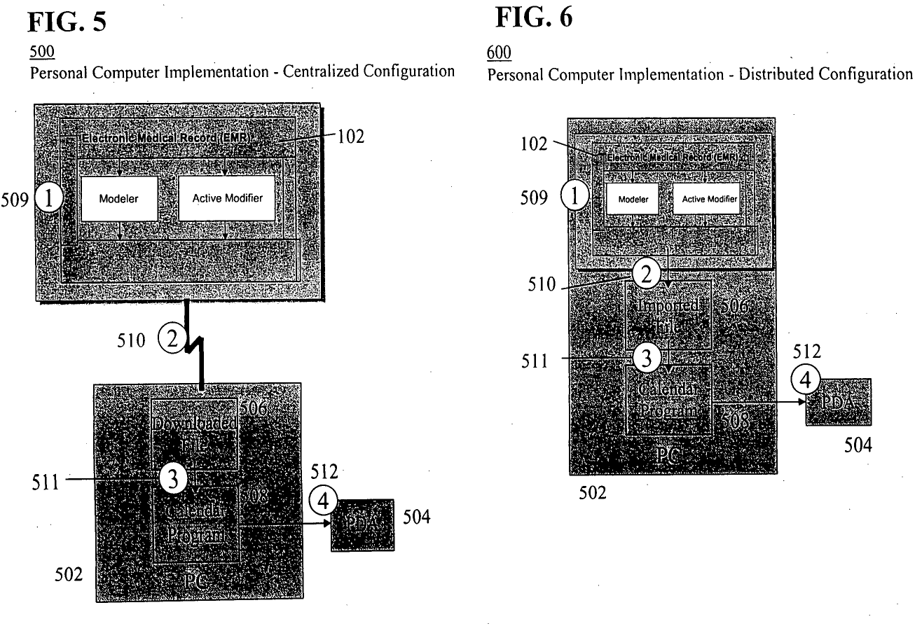

The system 100 is preferably used for one particular patient, but may be used for a group of patients, such as those related by a family, or any other group. The system 100 may be fixed or mobile (i.e., portable), and may be implemented in a variety of forms including, without limitation, a desktop computer, a laptop computer, a workstation, a network-based device, a personal digital assistant (PDA), a smart card, a cellular telephone, a pager, a wristwatch, as further described with reference to FIGS. 5-7. The system 100 may be implemented in a centralized configuration, as described with reference to FIG. 5, or in a distributed configuration, as described with reference to FIG. 6. Each of the referenced elements, as well as other known elements not shown, in the system 100 are interconnected in a manner well known to those skilled in the art of information systems.

The memory 112 and the repository 114 may be the same or different storage devices. Preferably, FIG. 1 illustrates the memory 112 and the repository 114 as two separate storage devices to highlight various aspects and functions of the system 100. Each of the elements of the processor 116, including elements 132, 134, and 136 may be the same or different processing elements. Preferably, FIG. 1 illustrates the processing elements 132, 134, and 136 as three separate elements 132, 134, and 136 to highlight various aspects and functions of the system 100. Further, the processor 116 and the communication processor 118 may be the same or different processing elements. Preferably, FIG. 1 illustrates the processor 116 and the communication processor 118 as two separate elements to highlight various aspects and functions of the system 100. In the EMR system 102, various combinations of the memory 112, the repository 114, the processor 116, and the communication processor 118 may be implemented as software, hardware, or a combination of software and hardware.

In the memory 112, the medical records 124 (otherwise called patient data files) represent health care information related to the person being serviced by the health care provider. The medical records 124 are an organized collection of clinical information concerning one patient's relationship to health care provided by a health care provider. Preferably, the health care is documented using order sets and document templates. Hence, the patient's medical records 124 represent the history of the patient's care by one or more healthcare providers.

The health care information generally includes case management information and/or claim processing information related to a patient's healthcare. For example, the health care information may include, without limitation and either alone or in combination: patient census information, clinical reports, images, documents and data associated with a patient record, patient record scanned documents, detailed information about a particular patient, patient medical eligibility determination related information, patient admission, discharge, and transfer related information, patient clinical information, patient care plan information, workflow information, patient bibliographic information, patient demographic information, patient vital signs, patient financial information, and patient accounting and billing information. Particular health care information includes characteristics of the person including, without limitation, the person's age, sex, and health condition.

Preferably, the medical records 124 are generated, originated, or sourced by one or more various healthcare sources within the system 100. Examples of the healthcare sources include, without limitation, a hospital system, a medical system, and a physician system, a records system, a radiology system, an accounting system, a billing system, and any other system required or desired in a system 100. The hospital system further includes, without limitation, a lab system, a pharmacy system, a financial system, and a nursing system. The medical system, otherwise called an enterprise, represents a healthcare clinic or another hospital system. The physician system represents a physician's office.

The medical records 124 may be represented in a variety of file formats including, without limitation and in any combination, numeric files, text files, graphic files, video files, audio files, and visual files. The graphic files include a graphical trace including, for example, an electrocardiogram (EKG) trace, an electrocardiogram (ECG) trace, and an electroencephalogram (EEG) trace. The video files include a still video image or a video image sequence. The audio files include an audio sound or an audio segment. The visual files include a diagnostic image including, for example, a magnetic resonance image (MRI), an X-ray, a positive emission tomography (PET) scan, or a sonogram.

Preferably, the memory 112 stores the medical record 124 in random access memory (RAM), or other suitable non-volatile memory unit that can be refreshed, cached, or updated while the EMR system 102 is in use.

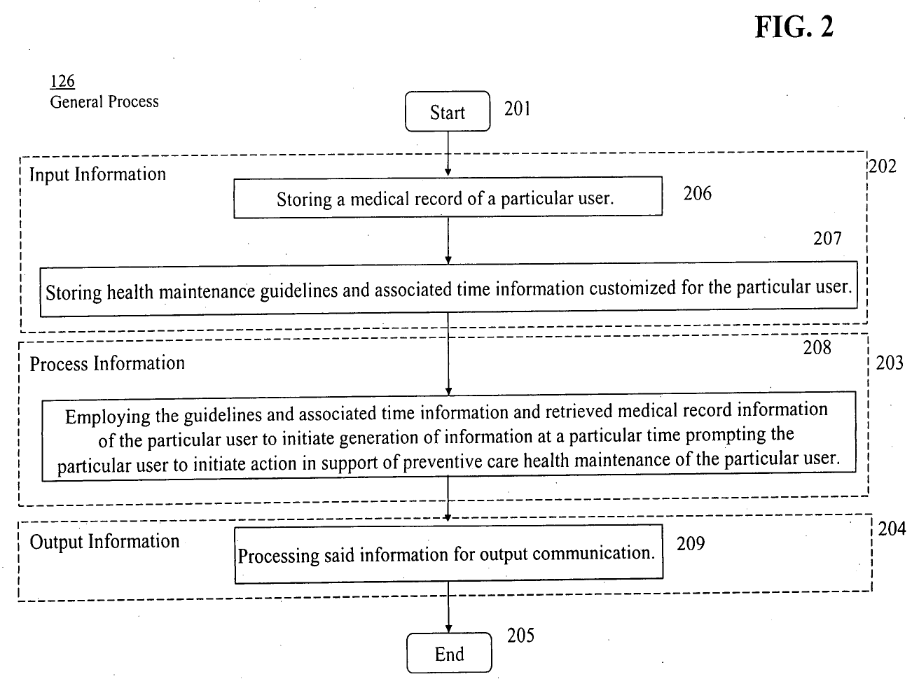

The memory 112 stores the process 126 for preventative care health maintenance, as described in FIGS. 2, 3, and 4. Preferably, the memory 120 that holds software to implement the process 126 is implemented in read only memory (ROM), or other suitable memory unit, which runs a predetermined software program while the EMR system 102 is in use.

In the repository 114, the health maintenance guidelines 128 (herein called “guidelines”) represent preventative and/or treatment plans, suggestions, standards, and the like, that reflect the most current knowledge and most reliable opinion of healthcare. The guidelines may be predetermined or variable.

In the repository 114, the schedule 130 represents time information to help coordinate the person's medical records 124 with the guidelines 128, responsive to the process 126. The schedule may be represented as a calendar, a list, a day, a date, a time, a year, a flowchart, a project or program management diagram, and the like. The schedule 130 may be very detailed, such as minutes in a day, and/or may be very general, such as years in a lifetime.

In the processor 116, the modeler 132 allows the person who defines the health guide to graphically edit the description of the process 126. The editing can be done with tools like a commercially available process editor of a workflow management system. The modeler 132 is also used to modify the process description in a passive way by a person who is asked to do so. In another embodiment, the system 100 modifies the process description automatically, without human interaction. Such modifications permit the lifelong electronic health guide to adapt to new medical insight, environmental changes, or other complex events. The modeler 132 also supports the definition of roles and rights attached to the steps in the process 126, and interfaces to external data systems such as the healthcare provider's databases.

In the processor 116, the active modifier 134 performs modifications of the description of the process 126 in an automated way, based on information collected through input elements, or triggered by new information in the individual's EMR system 102. The active modifier 134 permits closed-loop electronic health guides that automatically adapt to changing individual healthcare needs.

In the processor 116, the executor 136 acts as a software interpreter that monitors the lifelong electronic health guide, and executes all steps according to the time information 130. For example, the executor 136 analyzes an activity, takes parameter values from the activity and binds them to the parameters in output elements, and triggers the communication processor to send messages to one or more of the user interface 106, the healthcare provider 108, and the remote location 110.

The executor 136 may be enhanced by the quality manager 137, which collects, analyses, and displays data about the prevention and/or treatment process. The quality manager 137 component measures the activities of all parties involved in the prevention and/or treatment process. For example, the quality manager 137 tracks whether appointments took place, were postponed, rearranged etc. The quality manager 137 can also measure no-shows for an appointment and be able to trigger actions, for example, actions based upon a no-show situation. Preferably, the quality manager 137 measures the rate of denial and acceptance of service, for example, by measuring how often a time slot at a general practitioner's practice is demanded and denied or accepted.

The communication processor 118 is responsible for exchanging information via paths 120 and 122 between the one or more providers of the lifelong electronic health guide service and the individual covered by the lifelong electronic health guide and the care providers needed. The system 100 conducts communication through using any methods, in an active or passive way. Active communication methods include, for example, sending email messages, pager messages, automated phone calls, fax messages, and postal mail. Passive communication methods may be established by web mechanisms, for example, an individualized homepage at the lifelong electronic health guide service provider web site, where the individual covered by the electronic health guide can log in (preferably, via secure mechanisms) and look up his lifelong electronic health guide, enter data as requested from output elements, etc. The communication processor 118 may permit a party to easily modify his communication methods (e.g., phone, fax, email, videoconferencing, short message service (SMS), etc.) so that the system 100 is always up to date. Additionally the communication processor 118 preferably knows about qualities of the communication methods and is able to modify messages accordingly to the selected communication method (e.g., unified messaging service). Also, the communication processor 118 preferably is able to detect and report errors in the communication, for example, by using a receipt mechanism in email or short message service (SMS) and associated error processing system or other error processing system, for example. The receipt mechanism may involve different methods, for example, sending a fax, and simultaneously a SMS with a request to acknowledge the reception of the fax.

The system 100 is either a software application running at the electronic healthcare provider site, or an individualized software package to be installed on the personal computer (PC) of the individual covered by the lifelong electronic health guide and communicating with the healthcare providers. Such an arrangement could be considered similar to an individual Quicken® software package running on a person's private PC and communicating with banks.

Preferably, in the personal PC version of the lifelong electronic health guide, the modeler 132 and the active modifier 134 generate activities in a format the can be imported into desktop calendar programs such as Microsoft® Outlook® or personal digital assistant (PDA) devices such as the Palm® family of devices. With this configuration, a desktop calendar program or a PDA device performs the functions of the executor 136 and the communication processor 118.

The communication path 104 provides communications between the EMR system 102 and one or more of the user interface 106, the healthcare provider 108, and the remote location 110. The term “path” may otherwise be called a network, a link, a channel, or a connection. The communication path 104 may be the same path or different paths for each of the user interface 106, the healthcare provider 108, and the remote location 110, depending on the particular system 100.

The communication path 104 may use any type of protocol, otherwise called data format, including, without limitation, an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, an Institute Of Electrical And Electronic Engineers (IEEE) bus compatible protocol, and an Health Level Seven (HL7) protocol.

The communication path 104 may use any type of address scheme including, without limitation, an address corresponding to a type of protocol described above, and a Universal Resource Locator (URL), otherwise called a web page address. The communication path 104 may communicate any type of data for any type of application including, without limitation, still pictures, streaming video, audio, telephone messages, computer programs, messages, instructions, and Emails.

The communication path 104 may be formed as a wired and/or wireless (W/WL) connection. A wireless connection advantageously permits the system 100 to be mobile beyond the distance permitted by the wired connection. Preferably, the communication path 104 is formed as a wired connection. The wired connection may include physical wires formed as a serial or parallel bus. Preferably, in the case of a wired connection, an IP address may be assigned to a physical location of the termination point of the wire. In the case of a wireless connection, the IP address may be assigned to the provider system 101, since the provider system 101 would be mobile.

The communication path 104 may be formed as any type of network including, without limitation, a Local Area Network (LAN), such as an Intranet, for example, and a Wide Area Network (WAN), such as an Internet, for example. Preferably, the communication path 104 is formed as the WAN, such as the Internet. The Internet is a decentralized network of computers that communicate with one another via TCP/IP. The explosive growth in use of the Internet is due in part to the development in the early 1990's of the worldwide web (WWW), which is one of several services provided on the Internet. Other services include, without limitation, communication services such as Email, file transfer protocol (FTP), telnet, newsgroups, internet relay chat (IRC), instant messaging, information search services such as Google™ and AltaVista™, and information retrieval services such as file transfer protocol (FTP).

Preferably, in the case of a wired connection to the healthcare provider 108 and/or the remote location 110, the system 100 may be considered a server, and the healthcare provider 108 and/or the remote location 110 may be considered a client. A web browser, such as Explorer™ (MicroSoft Corp.) or Navigator™ (Netscape Communication Corp.), send a request over the WWW to a server requesting a web page identified by a uniform resource locator (URL), which notes both the server where the web page resides and the file or files on that server which make up the web page. The server sends a copy of the requested file(s) to the web browser, which in turn displays the web page to the user. The web pages on the WWW may be hyper-media documents written in a standardized language called Hyper Text Markup Language (HTML). A typical web page includes text together with embedded formatting commands, referred to as tags, which can be used to control font size, font style and the like.

Preferably, the user interface 106 in the system 100 includes an input device (not shown) that permits a user to input information into the EMR system 102 and an output device (not shown) that permits a user to receive information from the EMR system 102. Preferably, the input device is a keyboard, but also may be a touch screen, or a microphone with a voice recognition program, for example. Preferably, the output device is a display, but also may be a speaker, for example. The output device provides information to the user responsive to the input device receiving information from a user or responsive to other activity by the EMR system 102. For example, a display presents information responsive to a user entering information in the EMR system 102 via a keyboard.

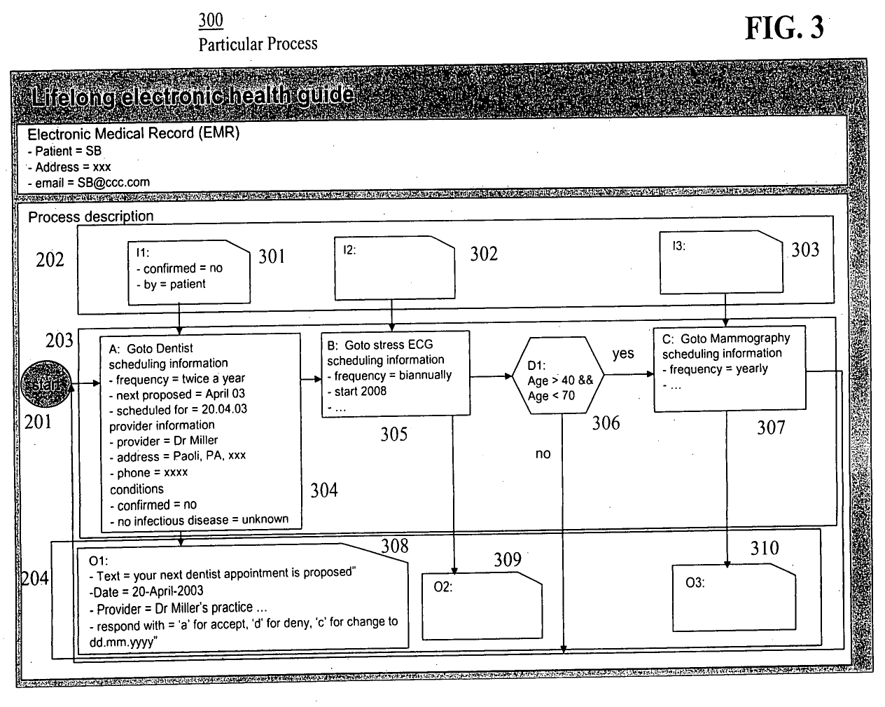

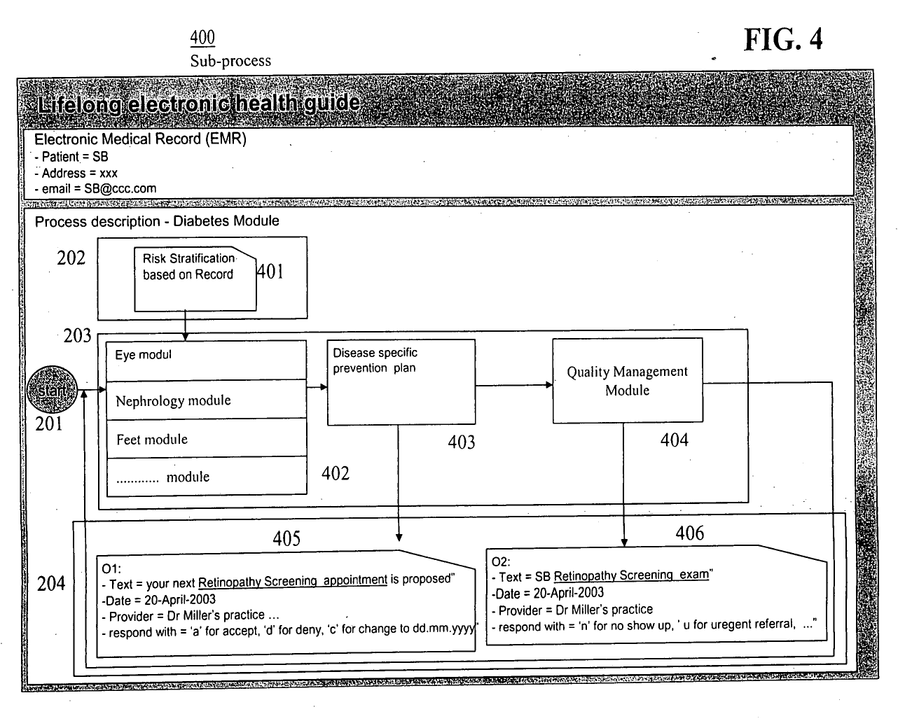

Preferably, browser software (not shown) stored in the memory 112 cooperates with the user interface 106 by permitting information to be entered into the browser software and by permitting information to be displayed by the browser software. Preferably, the user interface 106 includes a user interface generator that providing data representing a display image including information shown in FIGS. 3 and 4

Preferably, the user interface 106 is a graphical user interface (GUI), wherein at least portions of the input device and at least portions of the output device are integrated together to provide a user-friendly device. For example, a web browser forms a part of each of the input device and the output device by permitting information to be entered into the web browser and by permitting information to be displayed by the web browser. Many different GUI techniques for inputting data and outputting data, preferably using a browser interface, may be implemented for efficiency and ease of use including, without limitation, selection lists, selection icons, selection indicators, drop down menus, entry boxes, slide bars, search queries, hypertext links, Boolean logic, template fields, natural language, stored predetermined queries, system feedback, and system prompts. The healthcare provider 108 and/or the remote location 110 may also have a user interface (not shown), having an input device and an output device, which operates in the same or different way than the user interface 106.

In the preferred embodiment of the present invention, the system 100 provides a user with preventive care health maintenance information during a user's lifetime. The memory 112 stores a medical record 124 of a particular user. The repository 114 stores health maintenance guidelines 128 and associated time information 130 customized for the particular user based on characteristics including, age, sex, and health condition. The processor. 116 employs the guidelines 128, associated time information 130, and retrieved medical record information 124 of the particular user to initiate generation of a message on path 122 at a particular time. The message on path 122 prompts the particular user to initiate action in support of preventive care health maintenance of the particular user. The communication processor 118 processes the message for output communication to one or more of the user interface 106, the healthcare provider 108, and the remote location 110.

Preferably, the message on path 122 prompts a healthcare provider 108 to initiate action in support of preventive care health maintenance of the particular user. The communication processor 118 processes the message on path 122 for output communication to the healthcare provider 108. The message on path 122 may prompt a healthcare provider 108 to perform one or more of the following: (a) schedule an appointment for a healthcare related visit, (b) initiate preparation of a renewed prescription, and (c) obtain a financial record associated with a healthcare.

Alternatively or in combination, the message on path 122 prompts the particular user to do one or more of the following: (a) schedule an appointment for a healthcare related visit, (b) confirm acceptance of a scheduled appointment for a healthcare related visit, (c) access a message from a healthcare provider 108, (d) selecting a healthcare provider to provide a particular service, (e) make a reminder to attend a scheduled appointment, (f) make a reminder to take medication, (g) make a reminder to renew a prescription, (h) make a reminder to obtain a financial record associated with a healthcare related visit, (i) make a dietary related reminder, and (j) make a physical exercise related reminder.

Preferably, the processor 116 initiates generation of the message on path 122 prompting the particular user to initiate multiple actions in a prescribed and ordered sequence, such as, for example, those shown in FIGS. 3 and 4. Preferably, the processor 116 initiates generation of multiple messages via path 122 at a corresponding multiple different times prompting the particular user to initiate multiple actions in a prescribed and ordered sequence.

Preferably, the processor employs the guidelines 128 and associated time information 130 by testing characteristics of the retrieved medical record information 124 against criteria in the guidelines 128 and initiating generation of a message on path 122 in response to an outcome of the testing. Preferably, the processor 116 employs the guidelines 128 and associated time information 130 by testing data received from one or more of the following: (a) the particular user, and (b) a healthcare provider 108.

The repository 114 of health maintenance guidelines 128 may be customized for the particular user based on a health condition characteristic including one or more existing medical conditions of the particular user. The processor 116 initiates generation of a message on path 122 at a particular time in response to a treatment regimen associated with the one or more existing medical conditions. The repository 114 of health maintenance guidelines 128 may also be customized for the particular user based on one ore more module determining guidelines associated with one or more of the following: (a) a specific disease, (b) a specific medical condition, (c) a particular anatomical part, and (d) a particular anatomical function. Preferably, the information comprising the repository 114 of health maintenance guidelines 128 is one or more of the following: (a) received via encrypted communication from a remote location 110 in response to a user command, and (b) pre-stored in one or more files in a device hosting the system 100.

Preferably, the repository 114 includes guidelines 128 and associated time information 130 for identifying preventive care activities for performance by the particular user at particular times during an entire remaining user lifetime for maintaining and/or treating the health of the particular user.

Preferably, the adaptation processor 134 modifies the guidelines 128 in response to at one or more of the following: (a) a received message on path 120 identifying an update to preventive care medical information used in the guidelines 128, and (b) user editing of the guidelines 128.

Preferably, the quality manager 137 monitors implementation of preventive care health maintenance and identifying to a user via a message one or more of the following: (a) a record of failure to attend appointments, and (b) a record of failure to respond to data entry prompts.

The system 100 advantageously provides a lifelong health guide for individuals that define the activities and the timing of the activities necessary to actively support their preventative care health maintenance. The system 100 further reminds the individual of new or pending appointments, such as, for example, when to go for a health check, when to change a diet, when to visit the dentist for plaque removal, and so forth. The system 100 is designed in a simple way and with maximized automation, in order to bring as much convenience as possible to the individuals covered by the health guide.

In addition, the system 100 beneficially permits modification of the lifelong health guide responsive to new medical insight, changing needs of the individual covered, or additional needs coming from changing environments. For example, the identification of a new disease or the creation of a new vaccine may change established prevention activities. Those modifications may be done by the provider of the lifelong health guide, but could also be triggered automatically through feedback loops based on the continuous supervision of the individuals health parameters such as blood pressure, heart beat rate, weight, etc. Since not all preventive actions are planned in advance, the system 100 also provides the option to manually add reminder functions for the individual.

The system 100 advantageously supports primary, secondary, and tertiary preventive activities. Primary prevention focuses on measurements to prevent the manifestation of a disease. Secondary prevention focuses on avoidance, early recognition, and early treatment of disease specific complications. Tertiary prevention focuses on avoiding recurrences of complications of the disease. Hence, if an individual develops a disease such as hypertension, diabetes, asthma, or cancer, disease specific health guides would steer the person towards the necessary prevention measures.

In a similar way to the lifelong health guide for healthy individuals, a system 100 also defines, provides, and maintains episodic health guides for accident victims undergoing long lasting rehabilitation from home, and chronic disease health guides for people with diabetes, asthma, or other life-long health problems. Since the focus is on a lifelong health guide, the system 100 permits changes such as addresses, names, phone numbers, service profiles, etc. of the parties involved.

FIG. 2 illustrates a general process 126 for the preventative care health maintenance information system 100, as shown in FIG. 1, in accordance with a preferred embodiment of the present invention. The method for provides a user with user-specific preventive care health maintenance information during a user's lifetime. Preferably, the memory 112, shown in FIG. 1, stores the general process 126. The general process 126 generally has five steps 201-205, which are described as follows.

At step 201, the general process 126 starts.

At step 202, the EMR system 102 receives input information. Step 202 further includes steps 206 and 207. At step 206, the EMR system 102 receives and stores medical record information 124, shown in FIG. 1, of a particular user. At step 207, the EMR system 102 receives and stores health maintenance guidelines 128, shown in FIG. 1, and associated time information (e.g., the schedule) 130, shown in FIG. 1, customized for the particular user based on characteristics including, without limitation, age, sex and health (i.e., medical) condition.

At step 203, the EMR system 102 processes the input information. Preferably, the EMR system 102 processes the input information by employing the guidelines 128, the associated time information 130, and retrieved medical record information 124 of the particular user to initiate generation of information. Preferably, the generated information prompts the particular user at a particular time to initiate action in support of preventive care health maintenance of the particular user. Preferably, the information is a message. Alternatively, the information is Internet compatible web page representative data.

At step 204, the EMR system 102 generates output information. Preferably, the EMR system 102 generates the output information by communicating the information to one or more one of: a user, a healthcare provider, and a remote location. Preferably, the message is communicated to the user. Alternatively, the Internet compatible web page representative data is communicated to the user responsive to a user command.

At step 205, the general process 126 ends.

FIG. 3 illustrates a particular process 300 for the preventative care health maintenance information system 100, as shown in FIG. 1, in accordance with a preferred embodiment of the present invention. The particular process 300 generally includes the steps 201-204 of FIG. 2, and further includes detailed descriptions of steps 202-204. Step 202, describes receiving input information and further includes steps 301-303. Step 203, describes processing information and further includes steps 304-307. Step 204, describes generating output information and further includes steps 308-310.

Generally, descriptive formalisms (e.g., transition graphs, Petri nets, and similar graphically represented activity planning models), shown in FIGS. 3 and 4, may be used to model processes within the system 100, as are well known to those skilled in the art of computer science. The particular process 300 includes the following steps (otherwise called “elements” of the “descriptive formalisms”), which are described as follows.

Step 203 includes activity elements 304-307. For example, step 304 describes the activity element “Go to dentist.” Step 304 includes additional information fields including, without limitation, scheduling information, provider information, and condition information. Other areas and more information fields are possible. The scheduling information generally includes frequency, scheduled time, confirmation details, remainder details, etc., related to the activity. The scheduling information includes, for example, “frequency=twice a year,” “next proposed=April 2003,” and “scheduled for=20.04.03.” The provider information generally includes healthcare provider name, location, and contact information, etc., related to the activity. The provider information includes, for example, “provider=Dr Miller,” “address=Paoli, Pa., xxx,” and “phone=xxx.” The condition information generally includes prerequisites (which may be none) that need to be met before for the activity can occur. The condition information includes, for example, “confirmed=no,” and “no infectious disease=unknown.” Step 203 also illustrates activity element B at step 305 (“Go to stress ECG”) and activity element C (“Go to Mammography”) at step 307.

Arrows within or between the steps describe the order of the activities. For example, step 304 (activity element A) executes before step 305 (activity element B).

Decision elements test the value of parameters or make determinations related to input information received from other activity elements. Depending on the result of the test or determination, the next activity element to be triggered is either the one after the “yes arrow” or after the “no arrow.” For example, step 307 (activity element C) is started if step 306 (decision element D1) results in a positive determination, and no new activity starts if step 306 results in a negative determination. This permits process 300 to be available to re-start from the beginning at step 201.

Step 202 includes input elements 301-303. Input elements receive information for the system 101. For example, the information, such as responses, may be received from the parties connected to the EMR system 102 to be loaded into parameter fields, such as the “confirmed by” field in step 301 (input element I1) containing the inputs “no” and “patient.”

Step 204 includes output elements 308-310. Output elements generate information, such as messages that are sent from the EMR system 102 to the connected parties, from the system 100. For example, in step 308 (output element O1) the message is “your next dentist appointment is proposed for 20 Apr. 2003, Dr Miller's practice . . . ; respond with ‘a’ for accept, ‘d’ for deny, and ‘c’ for change to dd.mm.yyyy.”

FIG. 4 illustrates a sub-process 400 for the preventative care health maintenance information system 100, as shown in FIG. 1, in accordance with a preferred embodiment of the present invention. Preferably, the general process 126 permits the definition of particular processes 300 and sub-processes 400, and the building of complex processes by linking sub-processes entities together. The sub-process 400 generally includes the steps 201-204 of FIG. 2, and further includes detailed descriptions of steps 202-204. Step 202, describes receiving input information and further includes steps 401. Step 203, describes processing information and further includes steps 402-404. Step 204, describes generating output information and further includes steps 405-406.

FIG. 4 describes a sub-process 400 for a person with diabetes. Step 402 includes modules related to the treatment of various complications related to diabetes. Such modules include, without limitation, an eye module, a nephrology module, and a feet module. The sub-process 400 generates (i.e., triggers) a particular prevention and/or treatment plan for the disease at step 403 responsive to the various modules at step 402 processing the received risk stratification of the medical record of individual having diabetes from step 401. Parties involved into the preventive and/or treatment activities may generate input information to the system 100. For example, such input information may include documenting whether the patient came to the examination, if urgent action has to be taken, etc. Step 403 initiates generation of output information at step 405 (output element O1). For example, a particular prevention and/or treatment plan generates output information at step 405: “your next Retinopathy Screening appointment is proposed on 20 Apr. 2003, Dr. Miller's practice, etc., respond with ‘a’ for accept, ‘d’ for deny, ‘c’ for change to dd.mm.yyyy.” At step 404, a quality management module monitors the progress, effectiveness, etc., of the preventive and/or treatment plan and makes appropriate corrections and/or recommendations. Step 404 generates output information at step 406 (output element O2). For example, the quality management module at step 404 may generate output information at step 406: “SB Retinopathy Screening exam, on 20 Apr. 2003, Dr. Miller's practice, respond with ‘n’ for no show up, ‘u’ for urgent referral, etc.”

FIG. 5 illustrates the preventative care health maintenance information system 100, as shown in FIG. 1, implemented as a personal computer (“PC”) in a centralized configuration 500 in accordance with a preferred embodiment of the present invention. The centralized configuration 500 generally includes the EMR system 102, the personal computer 502, and a personal digital assistant 504. The personal computer 502 further includes a downloaded file 506 and a calendar program 508. The centralized configuration 500 further supports four steps 509-512, described as follows.

At step 509, the EMR system 102 generates activities for a particular individual. Preferably, a centralized modeler 132, as shown in FIG. 1, and active modifier 134, as shown in FIG. 1, in the EMR system 102 generate the activities.

At step 510, the EMR system 102 downloads a file containing activities, which are adapted to the person's age, sex and health status, to the personal computer 502, preferably, through a secure, encrypted connection.

At step 511, the personal computer 502 imports the downloaded file 506 into a desktop calendar program 508.

At step 512, if a PDA is available, the personal computer 502 may transmit the calendar program 508, having the imported downloaded file 506, to the PDA 504.

FIG. 6 illustrates the preventative care health maintenance information system 100, as shown in FIG. 1, implemented as a personal computer in a distributed configuration 600 in accordance with a preferred embodiment of the present invention. The distributed configuration 600 generally includes the EMR system 102, the personal computer 502, and a personal digital assistant 504. The personal computer 502 further includes an imported file 506 and a calendar program 508. The distributed configuration 600 further includes four steps 509-512, described as follows.

At step 509, the EMR system 102 is installed on the personal computer 502. Preferably, a user configures the modeler 132, as shown in FIG. 1, and active modifier 134, as shown in FIG. 1, in the EMR system 102 based on based on activities prescribed by his or her healthcare provider.

At step 510, the EMR system 102 generates an imported file containing activities, which are adapted to the person's age, sex, and health status, on the personal computer 502.

At step 511, the personal computer 502 imports the file 506 into a desktop calendar program 508.

At step 512, if a PDA is available, the personal computer 502 may transmit the calendar program 508, having the imported file 506, to the PDA 504.

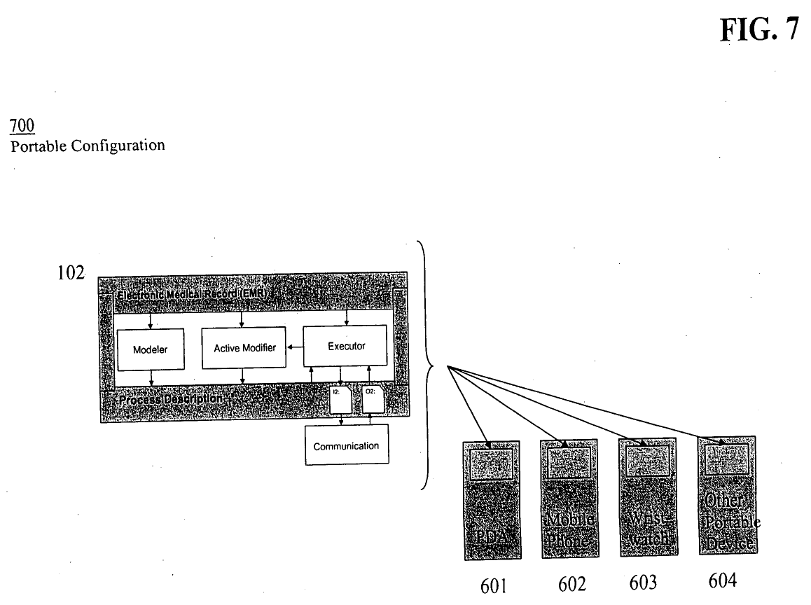

FIG. 7 illustrates the preventative care health maintenance information system 100, as shown in FIG. 1, implemented in a portable configuration 700 in accordance with a preferred embodiment of the present invention. The EMR system 102 may be implemented in a portable configuration 700. The portable configuration 700 permits the EMR system 102 to be installed directly in, on, or otherwise connected to, a PDA 601, a mobile phone 602, mobile phone 602, wristwatch 603, pager, or other portable device 604, etc. The EMR system 102 may be implemented in the form of a particular mechanical and electrical configuration, such as a smart card.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

What is claimed is:

1. A system for providing a user with preventive care health maintenance information during a user's lifetime, comprising:
a stored medical record of a particular user;
a repository of health maintenance guidelines and associated time information customized for said particular user based on characteristics including, age, sex and health condition;
a processor for employing said guidelines and associated time information and retrieved medical record information of said particular user to initiate generation of a message at a particular time, said message prompting said particular user to initiate action in support of preventive care health maintenance of said particular user; and
a communication processor for processing said message for output communication.

2. A system according to claim 1, wherein
said message prompts a healthcare provider to initiate action in support of preventive care health maintenance of said particular user, and
said communication processor processes said message for output communication to said healthcare provider.

3. A system according to claim 2, wherein
said message prompts a healthcare provider to at least one of, (a) schedule an appointment for a healthcare related visit, (b) initiate preparation of a renewed prescription, and (c) obtain a financial record associated with a healthcare.

4. A system according to claim 1, wherein
said message prompts said particular user to at least one of, (a) schedule an appointment for a healthcare related visit, (b) confirm acceptance of a scheduled appointment for a healthcare related visit, (c) access a message from a healthcare provider, (d) selecting a healthcare provider to provide a particular service, (e) a reminder to attend a scheduled appointment, (f) a reminder to take medication, (g) a reminder to renew a prescription, (h) a reminder to obtain a financial record associated with a healthcare related visit, (i) a dietary related reminder, and (j) a physical exercise related reminder.

5. A system according to claim 1, wherein
said processor initiates generation of said message prompting said particular user to initiate a plurality of actions in a prescribed and ordered sequence.

6. A system according to claim 1, wherein
said processor initiates generation of a plurality of messages at a corresponding plurality of different times prompting said particular user to initiate a plurality of actions in a prescribed and ordered sequence.

7. A system according to claim 1, wherein
said repository of health maintenance guidelines is customized for said particular user based on a health condition characteristic comprising at least one existing medical condition of said particular user, and
said processor initiates generation of a message at a particular time in response to a treatment regimen associated with said at least one existing medical condition.

8. A system according to claim 1, wherein
said repository of health maintenance guidelines is customized for said particular user based on at least one module determining guidelines associated with one or more of, (a) a specific disease, (b) a specific medical condition, (c) a particular anatomical part, and (d) a particular anatomical function.

9. A system according to claim 1, wherein
information comprising said repository of health maintenance guidelines is at least one of, (a) received via encrypted communication from a remote location in response to a user command, and (b) pre-stored in one or more files in a device hosting said system.

10. A system according to claim 1, wherein
said repository comprises guidelines and associated time information identifying preventive care activities for performance by said particular user at particular times during an entire remaining user lifetime for maintaining health of said particular user.

11. A system according to claim 1, wherein
said processor employs said guidelines and associated time information by testing characteristics of said retrieved medical record information against criteria in said guidelines 0and initiating generation of a message in response to an outcome of said testing.

12. A system according to claim 11, wherein
said processor employs said guidelines and associated time information by testing data received from at least one of, (a) said particular user, and (b) a healthcare provider.

13. A system according to claim 1, including
an adaptation processor for modifying said guidelines in response to at least one of, (a) a received message identifying an update to preventive care medical information used in said guidelines, and (b) user editing of said guidelines.

14. A system according to claim 1, including
a monitor for monitoring implementation of preventive care health maintenance and identifying to a user via a message at least one of, (a) a record of failure to attend appointments, and (b) a record of failure to respond to data entry prompts.

15. A method for providing a web site display image presenting a user with user specific preventive care health maintenance information during a user lifetime, comprising the activities of:
storing medical record information of a particular user;
storing health maintenance guidelines and associated time information customized for said particular user based on characteristics including, age, sex and health condition;
employing said guidelines and associated time information and retrieved medical record information of said particular user to initiate generation of Internet compatible web page representative data prompting said particular user at a particular time to initiate action in support of preventive care health maintenance of said particular user; and
communicating said web page representative data to a user in response to user command.

16. A system for providing a user with preventive care health maintenance information during a user lifetime, comprising:
a stored medical record of a particular user;
a repository of health maintenance guidelines and associated time information customized for said particular user based on characteristics including, age, sex, and a particular user medical condition;
a processor for employing said guidelines and associated time information and retrieved medical record information of said particular user to initiate generation of a message at a particular time, said message prompting said particular user to initiate action in support of preventive care health maintenance of said particular user; and
a communication processor for processing said message for output communication to at least one of, (a) a user display, (b) a healthcare provider, and (c) a remote location.

17. A system according to claim 16, including
said repository of health maintenance guidelines is customized for said particular user with information concerning at least one or more of, (a) a specific disease, (b) a particular anatomical part, and (c) a particular anatomical function.

18. A method for providing a user with preventive care health maintenance information during a user lifetime, comprising the activities of:
storing a medical record of a particular user;
storing health maintenance guidelines and associated time information customized for said particular user based on characteristics including, age, sex and health condition;
employing said guidelines and associated time information and retrieved medical record information of said particular user to initiate generation of a message at a particular time, said message prompting said particular user to initiate action in support of preventive care health maintenance of said particular user; and
processing said message for output communication.

19. A method for providing a user with preventive care health maintenance information during a user lifetime, comprising the steps of:
storing a medical record of a particular user;
storing health maintenance guidelines and associated time information customized for said particular user based on characteristics including, age, sex and a particular user medical condition;
employing said guidelines and associated time information and retrieved medical record information of said particular user to initiate generation of a message at a particular time, said message prompting said particular user to initiate action in support of preventive care health maintenance of said particular user; and
processing said message for output communication to at least one of, (a) a user display, (b) a healthcare provider, and (c) a remote location.
